(19) United States
(12) Patent Application Publication
(10) Pub. No.: US 2026/0203596 A1
(43) Pub. Date: Jul. 16, 2026

(54) ASYNCHRONOUS AND FAULT TOLERANT FEDERATED LEARNING FRAMEWORK WITH SPECIALIZED NODE SELECTION AND COMMUNICATION REDUCTION

(71) Applicant: Dell Products L.P., Round Rock, TX (US)

(72) Inventors: Pablo Nascimento da Silva, Niterói (BR); Paulo Abelha Ferreira, Rio de Janeiro (BR); Thais Luca Marques de Almeida, São Gonçalo (BR); Paulo de Figueiredo Pires, Niterói (BR); Vagner Ereno Quincozes, Niterói (BR); Julio C. H. Soto, Niterói (BR)

(21) Appl. No.: 19/019,422

(22) Filed: Jan. 13, 2025

(51) Int. Cl. G06N 3/098

(52) U.S. Cl. CPC G06N 3/098

(57) ABSTRACT

One example method includes sending a model to each node in a group of nodes that are connected with each other, receiving, from each of the nodes, a respective gradient for the model, running a federated learning process across the nodes, using the gradients to train the model, clustering the nodes into K clusters based on their respective gradients, selecting N champion nodes from the K clusters, where the N champion nodes represent all gradient results in each of the K clusters, receiving, from each of the N champion nodes, a respective gradient resulting from training of the model at the N champion nodes, aggregating the gradients, resulting from the training of the model at the N champion nodes, into a new or updated model which is then transmitted to the nodes.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to federated learning. More particularly, at least some embodiments relate to systems, hardware, software, computer-readable media, and methods, for an asynchronous and fault tolerant federated learning framework with specialized node selection and communication reduction.

### BACKGROUND

In the field of machine learning (ML), traditional methods that centralize data collection and aggregation on a single server present significant challenge related to data privacy, security, and communication overhead. Federated Learning (FL) emerged as a solution to these problems, enabling model training on decentralized devices or edge nodes, keeping data stored locally, and reducing the risk of exposing sensitive information. FL is particularly advantageous in scenarios like Industry 4.0. In FL, data sources are distributed across multiple devices, aiding in reducing data transfer, easing bandwidth constraints, and lessening the computational load on the central server.

Despite its benefits, FL faces challenges, particularly related to communication delays caused by synchronous update schedules among participating devices and the central server, aggravated by variability in local devices' training times. To mitigate such issues, Asynchronous Federated Learning (AFL) was developed to allow for asynchronous updates. In AFL, devices independently transmit their updates to the central server at their convenience, leading to faster training convergence and addressing issues related to unavailable devices and unstable connections. However, AFL still confronts challenges in resource-limited environments, such as restricted network bandwidth and energy constraints of computing nodes.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses a table of notations used in this disclosure.

FIG. 2 discloses aspects of an example framework for grouping clients based on node characteristics, according to one embodiment.

FIG. 3 discloses aspects of an example cross-node framework, according to one embodiment.

FIG. 4 discloses aspects of example cross-node framework flowcharts, according to an embodiment.

FIG. 5 discloses aspects of an example experimental setup preparation process, according to one embodiment.

FIG. 6 discloses a table indicating the impact of warm-up rounds on global model metrics using a basic CNN and CIFAR-10 Dataset, according to one embodiment.

FIG. 7 discloses a table indicating the impact of the number of clusters on global model metrics using a basic CNN and CIFAR-10 dataset, according to one embodiment.

FIG. 8 discloses a table indicating the impact of rounds to clustering on global model metrics using a basic CNN and CIFAR-10 dataset, according to one embodiment.

FIG. 9 discloses a table of experimental parameters, according to one embodiment.

FIG. 10 discloses a table of baseline results, according to one embodiment.

FIG. 11 discloses a table of cross-node results, according to one embodiment.

FIG. 12 discloses an example computing entity configured and operable to perform any of the disclosed methods, processes, and operations.

### DETAILED DESCRIPTION OF SOME EXAMPLE EMBODIMENTS

Embodiments disclosed herein generally relate to federated learning. More particularly, at least some embodiments relate to systems, hardware, software, computer-readable media, and methods, for an asynchronous and fault tolerant federated learning framework with specialized node selection and communication reduction.

One or more embodiments comprise a method, schema, and/or, architecture for an asynchronous, fault-tolerant, federated learning network. In an embodiment, the network may comprise edge devices, such as IoT devices and/or computing devices, and autonomous devices such as autonomous vehicles. In one example embodiment, a network may comprise multiple nodes configured to communicate with each other and/or with a central node that may reside at a near-edge location, or elsewhere. However, the scope of this disclosure, and that of any claims, are not limited to any particular type of network or environment.

One such method may comprise various operations including, but not limited to: creating a model for use by the nodes of a network; sending the model to a group of nodes that are connected with each other; training the model locally at each of the nodes, using local node data, so as to generate a node-specific gradient for the model; running a federated learning process across the nodes to train the model; clustering the nodes into K clusters based on their respective gradients; selecting N champion nodes from the K clusters, where the N champion nodes represent all gradient results in each of the K clusters; training the N champion nodes with their respective data to obtain respective gradients; returning model updates, or the gradients, from the N champion nodes to a central node; aggregating the gradients into a new/updated model; repeating the federated learning, clustering, selecting of N champion nodes, and training of the selected champion nodes until the model converges.

Methods, such as the example just discussed, may be such that some aspects of the method are performed at one or more nodes of a network, while other, possibly complementary aspects of the method, are performed at a central node or other central location with which the nodes communicate. Thus, example node operations, which may be performed by one or more nodes in a group of nodes, of one embodiment of a method may include, but are not limited to: receiving a model from a central node; training the model by/at the node; generating, by the node(s), a respective node-specific gradient for the model; transmitting the gradients to the central node; after being clustered with one or more other nodes, training, by N champion nodes of the group of nodes, the model at the N champion nodes; generating, and transmitting, gradients by the N champion nodes to the central node; and receiving the updated model after the model has converged. Any or all of these operations may be repeated until the model converges, or until a specified number of iterations have been performed.

In connection with the foregoing, example central node operations, of one embodiment of a method, may include: transmitting a model to each node of a group of nodes; receiving respective gradients generated by each of the nodes that have run the model; conducting a federated learning process across the nodes, using the gradients; clustering the nodes into K clusters; selecting N champion nodes from the K clusters; receiving gradients from the N champion nodes resulting from running of the model at the N champion nodes; aggregating the gradients into a new model; and sending the new model to the nodes. Any or all of these operations may be repeated until the model converges, or until a specified number of iterations have been performed.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that problems inherent to conventional AFL processes may be overcome. An embodiment may implement intelligent clustering of nodes for training purposes. An embodiment may select nodes for model training with a view to maximizing node usefulness while also reducing data traffic in a network. An embodiment may implement fault tolerance in a federated learning process and environment. Various other advantages of one or more embodiments will be apparent from this disclosure.

### A. Notations

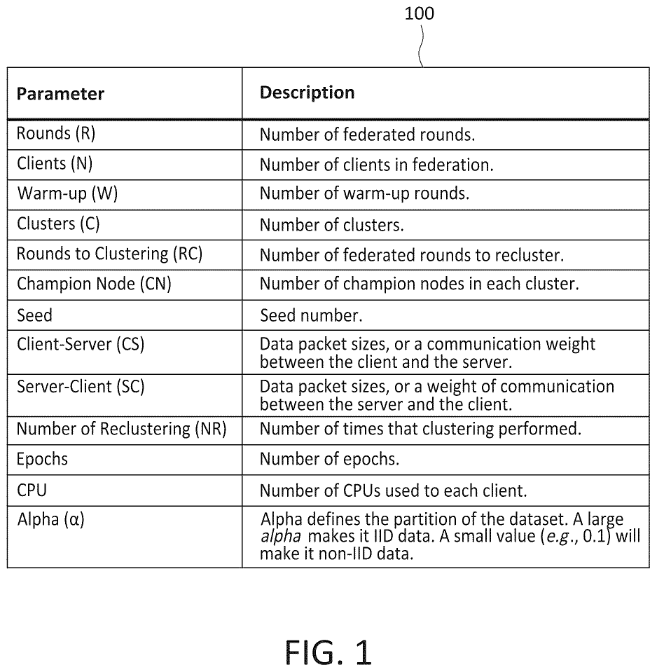

With reference to the example table 100 disclosed in FIG. 1, various notations are set forth that are referred to in this disclosure. These parameters are chosen and calibrated to ensure an effective and efficient federated learning process, and can play an important role in the challenges inherent in federated learning, such as data distribution, communication overhead, computational resource allocation, and model convergence.

### B. References

Reference is made herein to various documents, which are listed below. These documents are incorporated herein in their respective entireties by this reference.
[1] Learning Multiple Layers of Features from Tiny Images, Alex Krizhevsky, 2009.
[2] XIAO, Han; RASUL, Kashif; VOLLGRAF, Roland. Fashion-MNIST: a Novel Image Dataset for Benchmarking Machine Learning Algorithms. arXiv preprint arXiv:1708.07747, 2017.
[3] TAN, Mingxing; LE, Quoc. EfficientNet: Rethinking Model Scaling for Convolutional Neural Networks. PMLR, 2019. p. 6105-6114.
[4] HE, Kaiming et al. Deep Residual Learning for Image Recognition. In: Proceedings of the IEEE Conference on Computer Vision and Pattern Recognition. 2016. p. 770-778.
[5] ZHENG, Paul et al. Federated learning in heterogeneous networks with unreliable communication. IEEE Transactions on Wireless Communications, 2023.
[6] YESSOU, Hichame; SUMBUL, Gencer; DEMIR, Begum. A comparative study of deep learning loss functions for multi-label remote sensing image classification. In: IEEE International Geoscience and Remote Sensing Symposium. 2020. p. 1349-1352.
[7] BEUTEL, Daniel J. et al. Flower: A Friendly Federated Learning Research Framework. arXiv preprint arXiv:2007.14390, 2020.
[8] HIPOLITO, Mirian et al. FLUTE: A Scalable, Extensible Framework for High-Performance Federated Learning Simulations. ArXiv. 2022.
[9] HOLGER R Roth et al. NVIDIA FLARE: Federated Learning from Simulation to Real-World. Workshop on Federated Learning: Recent Advances and New Challenges (in Conjunction with NeurIPS. 2022.
[10] JAE Hun Ro et al. FedJAX: Federated learning simulation with JAX. ArXiv. 2021.
[11] EKAIREB, Emily et al. Ns3-fl: Simulating Federated Learning with ns-3. In Workshop on ns-3 (WNS3). New York, NY, USA. 2022.

### C. Glossary

| Term | Definition |
|---|---|
| Rounds (R) | Number of rounds. |
| Clients (N) | Number of clients in federation. |
| Warm-up (W) | Number of warm-up rounds. |
| Clusters (C) | Number of clusters. |
| Rounds to | Number of rounds to reclusterize. |
| Clustering (RC) | |
| Champion Node (CN) | Number of champion nodes in each cluster. |
| Seed | Seed number. |
| Client-Server (CS) | Data packet sizes, or a communication weight |
| | between the client and the server. |
| Server-Client (SC) | Data packet sizes, or a weight of communication |
| | between the server and the client. |
| Rounds of | Number of rounds to recluster. |
| Reclustering (NR) | |
| Epochs | Amounts of epochs. |
| CPU | Number of CPUs used to each client. |
| Alpha (a) | Alpha defines the partition of the dataset. A large |
| | alpha makes it IID data. A small value (e.g., 0.1) |
| | will make it non-IID data. |
| iid | Independent and identically distributed |

### D. Overview of Aspects of One Embodiment

### D.1 Introduction

To address challenges such as those noted herein, an embodiment comprises a “cross-node” framework, which may minimize communication costs and energy expenditure in the AFL process without compromising training effectiveness. In an embodiment, this is achieved through strategies such as clustering nodes with similar characteristics and dynamically selecting a minimal, yet effective, set of devices for each training phase. This approach resolves issues like maintaining diversity and efficiency in node selection, reducing communication overhead, smart client grouping, and enhancing fault tolerance, further improving the effectiveness of FL and AFL in decentralized and resource-restricted settings. In an embodiment, a cross-node framework may comprise features that may resolve various challenges:

1. Diversity and efficiency in node selection: cross-node selects champion nodes to reduce data traffic and save energy, maintaining system diversity and robustness.

2. Communication overhead: the cross-node framework significantly reduces communication costs while maintaining learning quality due to its random selection of champion nodes.

3. Intelligent client grouping: integrated with cross-node, Crossandra groups clients with similar gradients, optimizing collaboration and the learning process.

4. Fault tolerance: Incorporated strategies ensure the continuity of the learning process in case of failures, increasing system stability in scenarios of interruptions or network instabilities.

### D.2 Discussion

In more detail, an example embodiment may address such challenges through the introduction and use of a “cross-node” component in an FL framework. Thus, an embodiment may enable fault tolerance and diversity selection to the federation nodes, and may comprise an improvement over, and build upon, an AFL concept by incorporating a clustering approach with a methodology that may reduce network communication, while also implementing a fault tolerant configuration.

One example embodiment may comprise and/or implement elements and functions including, but not limited to:
Intelligent Clustering
   Groups clients with similar gradients to facilitate efficient collaboration and optimized learning.
   Enhances processing efficiency and the quality of federated learning.
Efficient Selection and Diversity
   Selects champion nodes to reduce data traffic and conserve energy.
   Employs randomness in node selection to ensure class diversity and robustness.
   Significantly contributes to the reduction of communication costs and energy usage.
Fault Tolerance
   Incorporates strategies to ensure the continuity of the learning process in case of failures.
   Ensures system stability during interruptions or network instabilities.

In more detail, an example embodiment may comprise a method that solves the problems of grouping clients with iid and non-iid data. An embodiment may comprise a grouping and selection mechanism to improve the accuracy of the results using a small number of clients. One such embodiment may implement the following:
Reduction of communication overhead by electing champion nodes: A cross-node framework, also referred to herein simply as “cross-node,” according to one embodiment minimizes communication overhead in Federated Learning (FL). In each federated round, cross-node randomly selects champion nodes, and only these nodes send their gradients to the central server. This approach ensures broad class representativeness within the cluster and promotes robust performance by leveraging the diverse knowledge acquired by clients. Additionally, cross-node achieves up to a 35.40% reduction in communication while maintaining excellent accuracy and loss results, effectively balancing communication efficiency with learning quality.
Method for grouping and selecting client nodes to participate in the federation: A method tailored to group and select clients in federated processes. This approach analyzes each client gradient directions and individual parameters, forming groups with similar gradient characteristics. This method not only facilitates collaboration among nodes with similar gradient patterns but also optimizes learning, resulting in a more efficient and effective federated process.
Fault tolerance. Node resilience with the dynamic selection of champion nodes, aiming to overcome common challenges in Federated Learning (FL), especially in scenarios where clients may not always be synchronized. This approach allows for the formation of groups of clients with similar gradients. In the event of a client failure, others in the same group can compensate, maintaining the integrity and continuity of the learning process. Simultaneously, the variable selection of champion nodes in each round provides additional robustness, ensuring that the dependency of the learning process does not concentrate on any single node.

### E. Detailed Discussion of Aspects of One or More Embodiments

### E.1 Introduction

Federated Learning (FL) is a collaborative Machine Learning (ML) framework that allows multiple devices or clients to train a shared model without the need to upload or share their raw data. In FL, each client has its own local dataset, which is often sensitive or private, and the goal is to aggregate their knowledge to build a global model without centrally storing or accessing the raw data. The main idea behind FL relies on each device training its own model using its local data, rather than sending the data to a central server. Then, all the models learned are aggregated in the central server.

In FL, the training process typically involves multiple rounds of communication between the clients and a central server. During each round, the clients update their local models using their local data, and, then they send only the model updates, such as gradients or model parameters for example, to the server. The server aggregates these updates to generate a new global model, which is then sent back to the clients for the next training round. This iterative process continues until the global model achieves the desired level of performance, or until the system reaches a given number of rounds.

Some advantages of FL include: (i) privacy: FL allows ML training on decentralized data and no sensitive data leaves the device; (ii) data security: FL operates on local data without the need to send it to a central server, thus, the risk of data breaches or unauthorized access to sensitive information is reduced. This makes FL suitable for scenarios where data security is a critical concern; (iii) scalability: FL can be applied to a large number of clients, making it suitable for scenarios with a massive number of distributed devices; (iv) lower communication costs: instead of transmitting raw data, FL only requires exchanging model updates, which significantly reduces communication costs; (v) low-latency: FL enables training models directly on edge devices, such as smartphones or loT devices, which reduces latency and enhances real-time performance; (vi) distributed learning: FL leverages the computational capabilities of multiple devices or clients to collectively train a model. This distributed learning approach enables parallel processing and can be more efficient than conventional centralized training, especially when dealing with a large dataset or complex models.

Overall, FL offers a privacy-preserving, secure, scalable, and efficient approach for collaborative model training in distributed systems. These advantages make it suitable for various applications, such as healthcare, finance, and IoT, where data privacy and security are critical considerations. However, a platform to simulate FL processes is required. As a baseline for the present discussion, reference is made to Flower (https://flower.ai/), which facilitates traditional FL by providing the necessary infrastructure for federated learning, federated evaluation, and federated analytics. This baseline enables the movement of ML models back and forth, training and evaluating them on local data, and then aggregating the updated models. The baseline provides the infrastructure to do exactly that in an easy, scalable, and secure way. In short, it presents a unified approach to FL, analytics, and evaluation. It allows the user to federate any workload, any ML framework, and any programming language.

The baseline design may comprise various characteristics, such as: (i) customizable: FL systems vary wildly from one use case to another. Baseline allows for a wide range of different configurations depending on the needs of each individual use case. (ii) extendable: Many components can be extended and overridden to build new state-of-the-art systems. (iii) framework-agnostic: Different ML frameworks have different strengths. Baseline can be used with any ML framework. (iv) understandable: baseline is written with maintainability in mind. The community is encouraged to both read and contribute to the codebase.

The baseline follows a general structure that addresses the concept of FL. First, initialize a global model on the server. Second, send this model to several connected organizations/devices (client nodes). Third, train models locally on the data of each organization/device (client node). Clients use their own local dataset to train their own local model. Fourth, return model updates back to the server. After local training, each client node has a slightly different version of the model parameters they originally received. Fifth, aggregate model updates into a new global model. Finally, repeat steps until the model converges.

### E.2 Discussion

To address challenges such as those noted herein, an embodiment may comprise the following modules:
Client clustering by data similarity.
Treatment of overhead and computational complexity.

The following subsections disclose various example aspects of one or more embodiments. Particularly, section E.2.1 describes a framework according to one embodiment, and section E.2.2 describes how to select a champion node and use it to train the federation.

### E.2.1 Client Clustering by Data Similarity

An example embodiment comprises a method for clustering clients in FL. One such embodiment uses K-Means and K-Medoid as the clustering methods to split clients into K different groups, where K is the number of clusters. However, any other clustering algorithm can be implemented. Following are some useful aspects of an embodiment:
Allows different configurations depending on the need of the new application.
Has components that can be extended and overridden to build brand-new systems.
Can be used with any ML framework, such as PyTorch, TensorFlow, Hugging Face Transformers, PyTorch Lightning, MXNet, scikit-learn, JAX, TFLite, and raw NumPy.

### E.2.1.1 Clustering Using K-Means and Model Weights

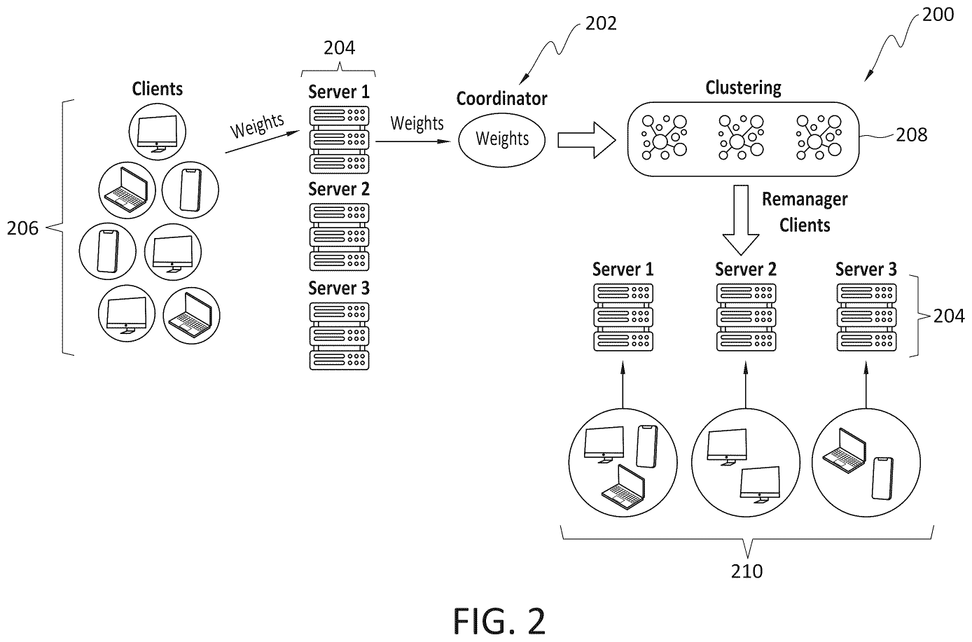

FIG. 2 discloses a schema 200 for the application of the client clustering. As noted herein, an embodiment may introduce an entity, the server coordinator 202, into the hierarchy of the clustering schema 200. As shown, the server coordinator 202 may work with multiple servers 204. The server coordinator 202 may be deployed in a cloud environment to manage clustering of the overboard clients 206, sending each group of clients 206 to their respective server 204, and adding the results to a global model. This contrasts with a conventional approach that employs a coordinator that directly manages all the overboard clients. An embodiment may also comprise one or more warm-up rounds before clustering to gain some information concerning local data of the clients 206 before clustering 208 the clients 206 into groups. The number of warm-up rounds is a hyperparameter, which is one by default. During warm-up rounds, every client 206 belongs to the same cluster 210 and each cluster is managed by a respective server 204. When a client 206 finishes its training, it passes its gradients, or parameters, to its corresponding server 204 to generate the final model of the cluster 210 that includes that client 206. Then, the server 204 sends these values to a coordinator (not shown in FIG. 2) that will perform the aggregation of the gradients or parameters in the final model.

### E.2.1.2 Clustering Using K-Medoid and SoftMax Layer Output

An approach according to one embodiment uses the softmax output of a neural network in combination with the Jensen-Shannon distance to optimize the clustering process. The Jensen-Shannon distance is applied to the softmax values of the clients, and the results are used as input for the K-Medoid algorithm. In addition to providing good clustering, this implementation promotes significant resource savings, as only the information derived from the last layer of the neural network is needed for clustering. Following are further details concerning a process that embodies this approach.
SoftMax Calculation per Client: Each client processes a set of images through the neural network. For each batch of images, an embodiment may calculate the softmax from the logits provided by the network. These softmax values are stored in a list, representing the probability of each entry belonging to a specific class.
Average of SoftMax Values: After processing all batches, an embodiment may calculate the average of these accumulated softmax values. This average transforms the softmax matrix, with dimensions of batch size by number of classes, into a single representative vector for each client. This vector is a representation of the probability distribution of classes for the samples processed by the client in a specific round of federated learning.
Utilization of Jensen-Shannon (JS) Divergence: After obtaining the average softmax values, an embodiment may apply the Jensen-Shannon (JS) metric to measure the similarity between the probability distributions of different clients. JS is suitable for comparing probability distributions, such as those provided by the softmax layer of the neural network, which sum to 1.
Clustering with K-Medoids: Using the distances calculated by the JS divergence, an embodiment may apply the K-Medoids algorithm to cluster the clients. In an embodiment, K-Medoids is used due to its similarity to K-Means and the ability to select actual data points (medoids) as cluster centers. Additionally, K-Medoids allows customizing the distance metric, unlike K-Means, which only uses Euclidean distance.

### E.2.2 Cross-Node: Extension for Treatment of Overhead & Computational Complexity

In an embodiment, cross-node significantly enhances a node selection mechanism by permitting the choice of one or more nodes (clients) to represent a comprehensive overview of the model performance across different clusters. This approach is based on the notion that these selected nodes are likely to reflect the final model behavior accurately, at least relative to unselected nodes, thus providing a reliable indication of model effectiveness on the data it was trained on. This selection is referred to as a champion node, in which an embodiment may opt for selection of a finite number of nodes within each cluster. This selection process is used for managing overhead and computational complexity.

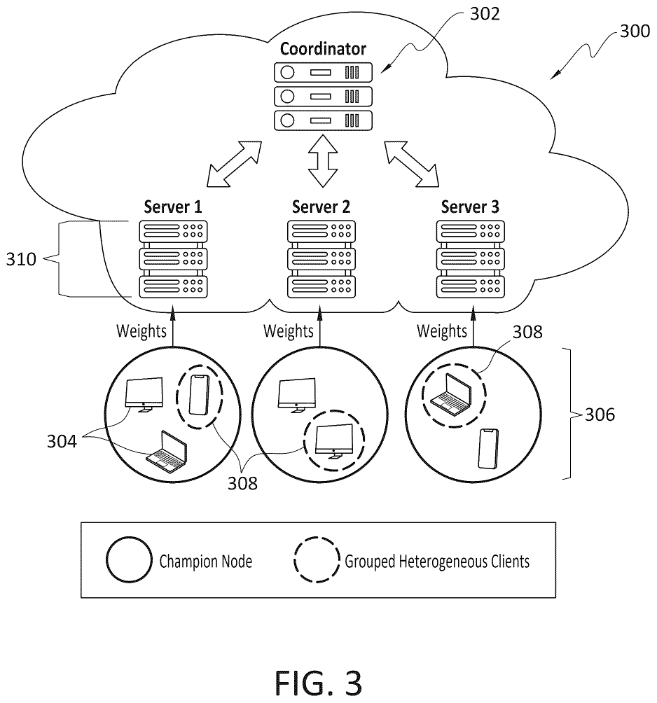

With attention now to FIG. 3, an example of a cross-node framework 300 according to one embodiment is disclosed. To exemplify the operation of a cross-node framework 300, the following operations may be implemented in one embodiment:
1. Create a global model. The server coordinator, or simply ‘coordinator,’ 302 is initialized. In this step, an embodiment may also setup hyperparameters, such as warm-ups and rounds to clustering.
2. Send model to several connected client nodes. The coordinator sends the global models to each client, examples of which are referenced at 304.
3. Train model locally on the data of each client node. Here, the client 304 runs the warm-up step, and generates a gradient after completion of the training.
4. Run federated rounds. After running the warm-up rounds, the model runs conventional federated learning rounds to train the model.
5. Cluster the clients in K clusters. Based on gradient results, the clients are grouped into clusters 306 for data similarity—for this operation, an embodiment may use the rounds to be clustering hyperparameter.
6. Select N champion nodes from the K clusters. The model chooses a finite number of clients, or nodes, 304 from each cluster 306 where the selected nodes together represent all gradient results in their respective cluster 306.
7. Training of the selected champion nodes. Those champion nodes 308 train with their respective local data and return their gradients, to a coordinator 302, by way of an associated server 310, as results.
8. Return model updates from champion nodes to the global server. An embodiment may aggregate model updates, such as parameters or gradients, into a new, or modified, global model.
9. Repeat operations 4 to 7 until the model converges, after which the model may be distributed to all the nodes, or a subset of the nodes.

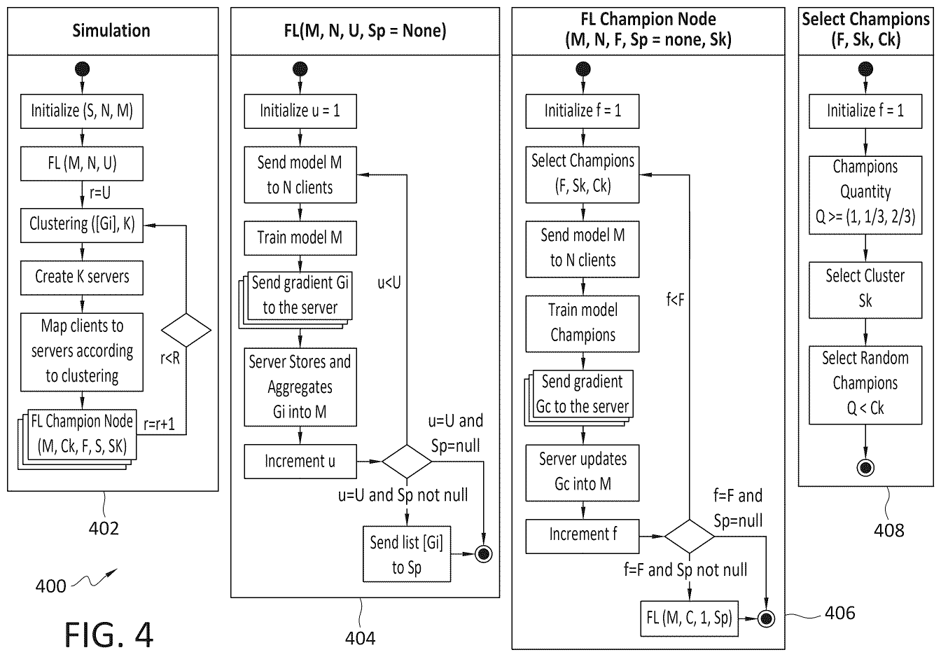

FIG. 4 discloses an example of a cross-node framework 400 according to one embodiment. Various flowcharts 402, 404, 406, and 408, each with respective hyperparameters, indicate aspects of the operations of an embodiment. Initially, an embodiment may define the hyperparameters as Server (S), Client (N), Model (M), Number of rounds (U), Clusters (K), and Parent Server (Sp). Following this, an embodiment may initialize S, C, and M as the main server, the coordinator, and the number of nodes, respectively, and then create a global model. This marks the beginning of a simulation process, shown in flowchart 402, according to one embodiment, where, upon initiating the FL process, the global model is dispatched to nodes (clients) to undertake the simulation with a predetermined number of rounds. Subsequently, the clustering process is executed, grouping the nodes (Gi) into K clusters. For each cluster, K servers are established, with each server remnant representing its corresponding group of nodes. This necessitates mapping each node to its respective server. Finally, after each clustering phase and round, champion nodes are selected, a process that is reiterated in subsequent rounds.

The flowchart 404 discloses FL rounds. As noted above, a simulation—see flowchart 402—uses federated rounds as a process. As shown in the flowchart 404, FL rounds are executed on all nodes. Each node retains its server references. The global model is sent to nodes and each node trains the model with local data. After each node gets a gradient result, it sends it to the corresponding server. Servers store and aggregate gradients. This flow continues along the federated rounds.

Regarding the execution of the FL champion node, shown in flowcharts 404 and 406, this phase of an embodiment initiates a selection mechanism aimed at choosing a specific quantity of nodes to represent the entire node network. The selection criteria may involve choosing approximately one-third or two-thirds of the total node count or opting for a single node from each cluster. Given the random nature of this selection, it is plausible for the same champion nodes to be chosen across multiple rounds. Each selected champion node proceeds to train its model with its data and then sends the gradient back to the corresponding server. This sequence mirrors the procedures outlined in the FL rounds, shown in flowchart 404, with the repetition continuing until the model achieves convergence.

### E.2.3 Fault Tolerance: Achieving Resilience

Fault tolerance may be an important aspect in FL, especially when considering the likelihood of client failures and network instabilities. Above, the clustering and cross-node operations of an embodiment of a framework were introduced, each contributing different features. Following is a discussion of how, in one embodiment, the integration of these parts accomplishes another objective of an embodiment, namely, achieving fault tolerance in a federated learning system.

In more detail, the two features work in collaboration to enhance fault tolerance. The first step is a framework of grouping clients based on gradient similarities dovetails with the cross-node dynamic selection of champion nodes. This synergy may ensure that the system can withstand client failures or network issues without significant disruption to the learning process.

A method according to one embodiment leverages the adaptive redundancy in the clustering step. In scenarios where a client node fails or becomes unstable, other nodes within the same gradient group can compensate. This redundancy may ensure the continuity and integrity of the learning process, preventing any single point of failure.

As well, the cross-node strategy of randomly selecting different champion nodes in each federated round adds more robustness. This variability in selection ensures a broad representation of data classes and prevents over-reliance on any single node for learning continuity. This approach not only maintains system stability but also contributes to the diversity and quality of the learning process.

Then, by integrating the two features, a federated learning system according to one embodiment effectively addresses the requirement of fault tolerance. This integration may ensure that the system is resilient to disruptions, maintaining the learning process continuity and integrity.

### E.2.4 Network Cost Evaluation

In assessing the performance and efficiency of federated learning as network, there may be some costs, each tailored to capture a unique aspect of model behavior and network interaction.

Total Messages (T): To quantify the communication overhead in an FL setup, an embodiment may count the number of messages exchanged between clients and the server. This metric can be important, given the challenge of balancing communication costs with model performance in FL. One embodiment may define this metric through two specific equations, presented below.

Equation 1 (below) addresses the communication expenditure during the warm-up rounds. Warm-up rounds are initial training phases where models gradually adapt to the distributed data. This equation (1) calculates the total communication load during these initial stages. Especially, W denotes the number of warm-up rounds, SC+CS encapsulates the bidirectional communication weight, incorporating both the server-to-client (SC) and client-to-server (CS) data packet sizes or communication weights, and N represents the number of nodes (clients) in the federation. By applying this equation, an embodiment may determine the total number of Warm-up Messages (WM).

$$W M = W \times ( S C + C S ) \times N \qquad ( 1 )$$

Equation (2) below focuses on the total number of messages exchanged throughout the entire learning process. This includes not only the warm-up phase but also the subsequent rounds of training and model updating. It provides a full view of the communication burden over the entire federated learning process.

$$R = W M + F R + C R + R R \qquad ( 2 )$$

In equation (2), FR refers to Federated Rounds, a component calculating the communication volume during regular federated training rounds. Specifically, FR comprises the term R×(SC×N), which denotes the number of messages exchanged during these rounds. Here, R represents the total number of federated rounds, SC is the communication weight, such as data packet sizes or a unit of communication measure for example, between the server and the client, and N is the number of clients in the federation.

Also, in equation (2), CR refers to Champions Rounds, which accounts for the communication volume during rounds that involve the selection of champion nodes. CR is represented by the term (R−NR)×(C×CN×CS), calculating the communication volume for these specific rounds. In this context, R−NR indicates the rounds before reclustering, C is the number of clusters, CN is the number of champion nodes within each cluster, and CS is the communication weight between the client and the server.

Finally, again in equation (2), RR stands for Reclustering Rounds, focusing on the number of messages exchanged during the rounds of reclustering. RR is encapsulated by the term NR×N×CS, quantifying the communication during these rounds. NR is the number of rounds until reclustering, N is the number of clients, and CS once again represents the communication weight between the client and the server.

Data transmitted size (P): Once an embodiment has calculated the total number of messages used, the embodiment may generalize this formula to find the data transmitted size in the network. For example, if there is an experiment that uses champion nodes and the softmax mean, the economy will be reflected in the use of the calculated softmax mean, which, compared to using all network outputs, an embodiment may use the softmax mean, which will always be one, according to equation (3):

$$P = NClass \times NB \qquad ( 3 )$$

where NCLass represents the number of classes used in the experiments and NB represents the number of batches that are used. Since in this case it is the softmax mean, it will always be one. This enables a reduction in the data transmitted size.

$$H = T \times P \qquad ( 4 )$$

After calculating the data size P, an embodiment may generalize the total information transmission size equation. In equation (4), the calculation made is shown, considering the number of messages used, as in equation (2), by the data size to be transmitted, where H is the result of the total size of the data transmitted considering the total number of messages.

It is noted that one embodiment may use two different ways of clustering, which are K-means and K-medoid. Both methods use the same network cost evaluation. The main difference in the use of network cost is in the configuration of champion nodes (CN), this varies from model to model. That is, if an embodiment opts for a traditional federated model, it evaluates the network cost with all edge nodes involved in the experiment. The opposite occurs in a federated model with the limitation of edge nodes, where an embodiment may choose champion nodes that represent a sample of the data. In this case, the quantity of nodes is limited and the CN starts to have small values, which optimizes the number of messages exchanged on the network and the size of the data sent. Besides, the formulas presented represent a generalization of the network cost. This can represent a specific unit depending on the type of implementation that is carried out.

### F. Example Experiments and Results

In this section, there is presented a discussion of the experimental analysis of a study conducted by the inventors. This discuss will cover the datasets used, the neural networks employed, the specific configurations and parameters, the adopted evaluation metrics, and the necessary preparations for conducting the experiments.

### F.1 Dataset and Neural Network (NN)

In conducting this experiment, only one dataset was used, namely, CIFAR-10. The CIFAR-10 dataset is a well-known benchmark in the machine learning field. Comprising 60,000 images, that dataset presents a balanced collection with 6,000 images per class across 10 classes. The 32×32 color images are split into a training set of 50,000 images and a test set of 10,000 images. The diversity and size of CIFAR-10 make it ideal for assessing the performance and generalizability of learning models. See [1].

The inventors selected a neural network architecture, named ResNet-18, to perform experiments. ResNet-18 as part of the ResNet family, stands out for its 18 layers and the use of “residual connections.” These connections help in easing the training of deeper networks by allowing gradients to flow through the network more effectively. This feature is particularly beneficial for training on larger and more complex datasets, as it significantly mitigates the problem of vanishing gradients. See [4]. ResNet-18 is widely recognized for its effectiveness in image classification tasks, making it a robust choice for federated learning experiments.

### F.2 Experimental Preparation

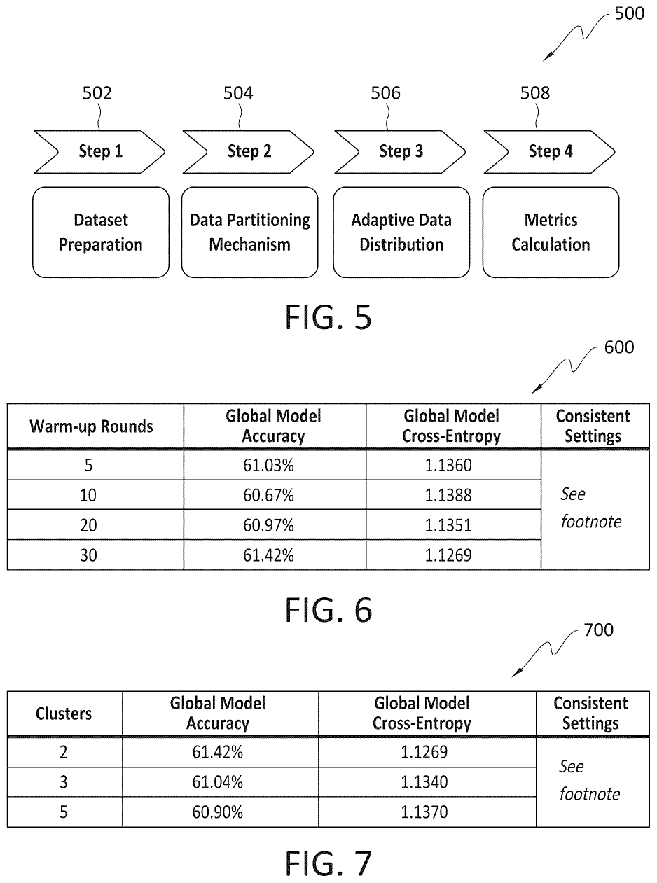

This section outlines the preparation of the experimental setup for ensuring the validity and reliability of the federated learning study of the inventors. The preparation involves several operations, illustrated in the example schema 500 disclosed in FIG. 5, each tailored to mimic real-world data distribution scenarios and optimize learning efficiency.

### F.2.1 Dataset Preparation

The inventors began by generating 502 a unified training set, which is subsequently partitioned. Training and testing data are handled separately to maintain the integrity of the evaluation process and to avoid any data leakage between training and testing phases.

### F.2.2 Data Partitioning Mechanism

The approach employed in the experiments employs Latent Dirichlet Allocation (LDA) for data partitioning 504. This method allows for dynamic allocation, where data is divided among clients based on the total number of participants. Additionally, each client data is internally split into training and validation subsets, enabling a more robust model evaluation within each client environment.

### F.2.3 Adaptive Distribution for Scalability

An embodiment is configured to be adaptable 506 to varying numbers of clients, showcasing scalability. In one embodiment, this flexibility may be achieved by manipulating the Alpha (α) parameter, which controls the homogeneity or heterogeneity of data distribution:
1) Homogeneous Data (High α, e.g., α=1000): Here, data distribution among clients is uniform, representing scenarios where data variance across clients is minimal.
2) Heterogeneous Data (Low α, e.g., α=0.5): This setting allows for varied data distribution among clients, catering to diverse and realistic federated learning scenarios.

The percentage of data that each client receives is dynamically calculated 508 based on the total client count and dataset size. This strategy closely resembles real-world data distribution scenarios in federated learning environments. During the training phase, the loss for each batch within the training set is calculated using the cross-entropy loss function. This process informs the backpropagation, enabling the updating of model weights through the optimizer, specifically using Stochastic Gradient Descent (SGD).

In summary, the experimental preparation just described, with its focus on realistic data partitioning, scalable and adaptable data distribution ensures a comprehensive and realistic assessment, closely aligned with real-world applications and challenges in federated learning systems.

### F.3 Results and Discussion

This section presents the results and discussions derived from the study conducted by the inventors. Specifically, the inventors conducted a detailed parameter analysis, compared the performance of the FL baseline and cross-node, and delved into the insights gained from the champion node analysis.

### F.3.1 Parameter Analysis

Following is a discussion of the impact of varying different parameters such as the number of warm-up rounds, the number of clusters, and the frequency of rounds to clustering. This parameter analysis is for optimizing the federated learning process and understanding how each variable influences the overall system performance. By testing and adjusting these parameters across a range of values, the inventors aim to identify the most effective configurations for various federated learning environments. In this analysis of parameters, the inventors opted to use a simple Convolutional Neural Network (CNN) and the CIFAR-10 dataset for agility. The simplicity of the CNN allows for quicker iterations and evaluations, while the CIFAR-10 dataset provides a consistent benchmark for measuring the efficacy of our FL models under different parameter settings.

### F.3.1.1 Number of Warm-Up Rounds

The warm-up rounds in federated learning are an important aspect of the inventor analysis. These initial rounds serve as a preparatory phase for the global model, enabling the model to begin learning from the decentralized data before entering the main training phase. To evaluate the impact of the number of warm-up rounds on model performance, the inventors conducted experiments with varying numbers of these rounds. The outcomes of these experiments are summarized in the table 600 disclosed in FIG. 6 (footnote: Consistent Settings: Rounds: 300, Clients: 20, Warm-up Rounds: 5, 10, 20, and 30, Clusters: 2, Rounds to Clustering: 1, Seed: 42, Champion Node: 1, Training Epochs: 1, α: 1,000), showcasing the global model accuracy and cross-entropy corresponding to different numbers of warm-up rounds.

The results in the table 600 (Impact of Warm-up Rounds on Global Model Metrics using a Basic CNN and CIFAR-10 Dataset) reveal a noteworthy trend. While the number of warm-up rounds varies, the impact on both the accuracy and cross-entropy of the global model are relatively marginal. This observation suggests that many warm-up rounds may not be critical for model performance. In fact, a higher number of warm-up rounds could lead to increased communication overhead without corresponding benefits in accuracy or loss reduction.

Given these findings, the inventors decided to set the number of warm-up rounds to 5 for subsequent experiments. This decision was based on the observed minimal impact of additional warm-up rounds on model performance, combined with the need to maintain a balance between effective learning and communication efficiency.

### F.3.1.2 Number of Clusters

The configuration of clusters within FL environments plays a crucial role in the data aggregation and model training processes. To understand the influence of the number of clusters on our global model performance, the inventors conducted a series of experiments with varying cluster counts. The objective was to ascertain the optimal number of clusters that would yield the best balance between model accuracy and efficiency. FIG. 7 (footnote: Consistent Settings: Rounds: 300, Warm-up Rounds: 5, Clusters: 2, 3, and 5, Clients: 20, Rounds to Clustering: 1, Seed: 42, Champion Node: 1, Training Epochs: 1, α: 1,000) discloses a table 700 (Impact of Number of Clusters on Global Model Metrics using a Basic CNN and CIFAR-10 Dataset) that presents the results of these experiments, highlighting the global model accuracy and cross-entropy for different cluster configurations.

The data obtained from these experiments suggest that the number of clusters has a limited impact on the overall results of the model. Particularly, the accuracy and cross-entropy do not show significant variations with the change in the number of clusters. This outcome indicates that, within the tested configuration at least, a higher number of clusters does not necessarily translate into better performance of the global model.

Therefore, based on these findings, the inventors decided to set the cluster count to 2 for subsequent experiments. This decision is grounded in the observation that increasing the number of clusters beyond this point does not substantially enhance model performance, while potentially adding complexity to the FL process.

### F.3.1.3 Number of Rounds to Clustering

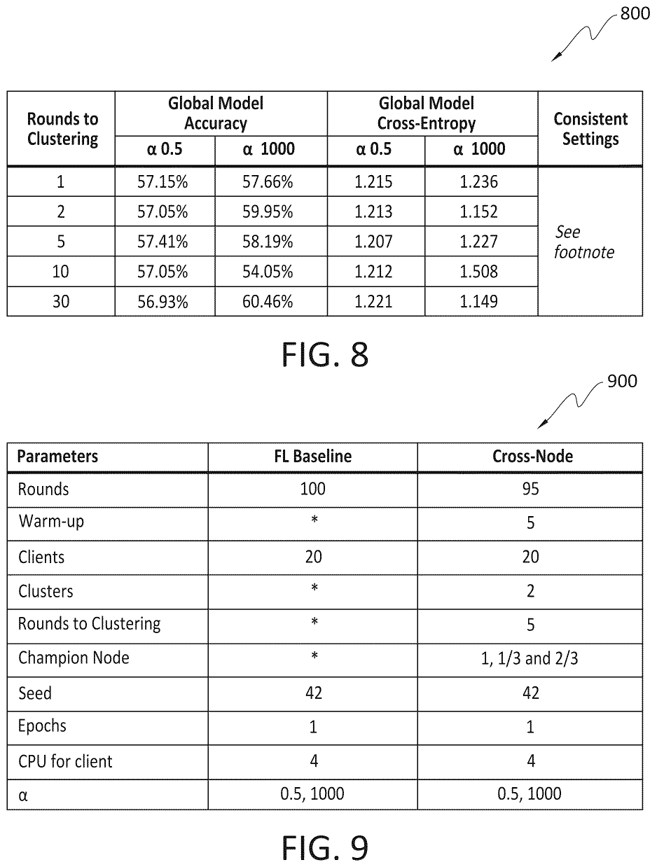

Varying the number of rounds clustering may impact the performance of the FL model. This analysis helps in understanding how frequently the data should be clustered during the learning process, especially under varying data distribution scenarios. To this end, we conducted experiments under both heterogeneous (α=0.5) and homogeneous (α=1000) data conditions. The results of these experiments, as presented in the table 800 (Impact of Rounds to Clustering on Global Model Metrics using a Basic CNN and CIFAR-10 Dataset) disclosed in FIG. 8 (footnote: Consistent Settings: Rounds: 300, Warm-up Rounds: 5, Clusters: 2, Clients: 20, Rounds to Clustering: 1, 2, 5, 10, and 30, Seed: 42, Champion Node: 1, Training Epochs: 1, α: 1,000 and 0.5), offer insights into the optimal frequency of clustering for different data distribution types.

From these results, it is evident that the number of clustering rounds has a varied impact on the model accuracy and cross-entropy, particularly when comparing heterogeneous and homogeneous data scenarios. Notably, a higher “rounds to clustering” value, such as 10, does not always guarantee improved performance. In fact, with homogeneous data (α=1000), the inventors observed a decline in performance (i.e., to 54.05%). This suggests that the frequency of clustering should be carefully calibrated to avoid detrimental effects on the model.

Furthermore, it may be important to consider the computational costs associated with clustering. A smaller value for this parameter implies more frequent clustering rounds, which can lead to increased computational demands. Balancing the number of clustering rounds with computational efficiency may be important for an optimal FL system.

Therefore, based on these observations, the inventors decided to set the “rounds to clustering” parameter to 5 in subsequent experiments. This decision strikes a balance between minimizing the number of exchanged messages and achieving optimal model results, both in terms of accuracy and cross-entropy, under varying data distribution conditions. This approach ensures that the model remains efficient and effective across different federated learning scenarios.

### F.3.2 Comparison: Client Parameter-Based Clustering and SoftMax.

Following is a detailed analysis of cross-node clustering using the K-Means algorithm, based on client parameters, and the K-Medoids algorithm, leveraging the Jensen-Shannon metric from Softmax.

### F.3.2.1 Parameters Used in the Experiments

The table 900 (Experimental Parameters) disclosed in FIG. 9 presents the parameters used for the experiments across these frameworks, chosen based on their proven effectiveness, as discussed earlier herein.

With reference to the table 900, the inventors established the number of rounds at 100, a point where the inventors observed the models converging in previous experiments, thus providing a consistent basis for comparison. The warm-up rounds, rounds to clustering, and the number of clusters were chosen based on the optimal values determined from the analyses discussed above. The inventors involved 20 clients in the study to reflect a robust and scalable federated learning environment. To maintain consistency and allow for reproducibility of results, a fixed seed value of 42 was used across all experiments. Additionally, the inventors allocated 4 CPUs to each client, a decision aimed at accelerating the learning process. The a parameter was set at 0.5 and 1000 to simulate both heterogeneous and homogeneous data scenarios, reflecting real-world conditions and idealized environments, respectively.

### F.3.2.2 Results

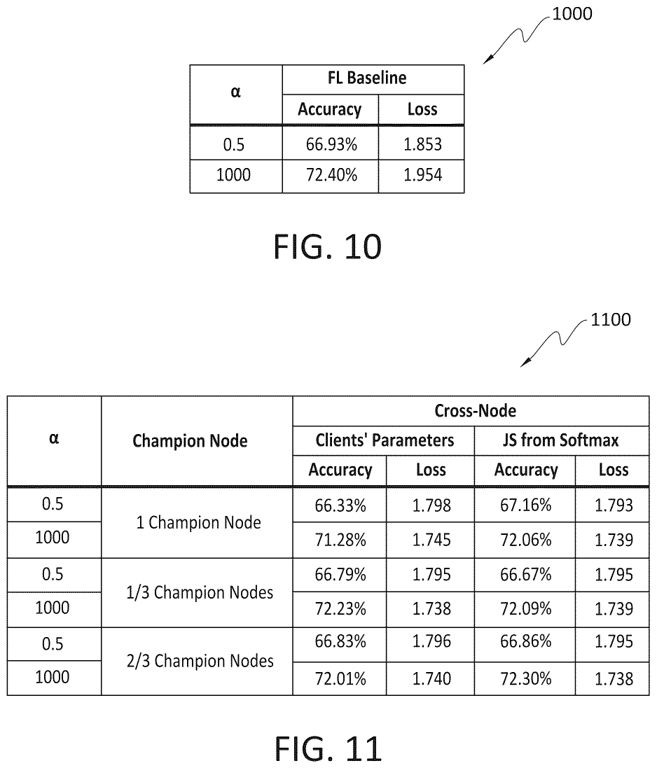

The inventors used the CIFAR-10 dataset in conjunction with the ResNet18 neural network architecture to evaluate the performance of FL models. The experiments were designed to reflect real-world data distributions by incorporating heterogeneous data with an a value of 0.5 and homogeneous data with an a value of 1000. Below are presented the FL Baseline results, as summarized in the table 1000 (FL Baseline results) disclosed in FIG. 10. These results establish a benchmark for subsequent comparisons.

After the baseline evaluation, we delve into. This analysis of the performance of the Cross-Node framework investigates various clustering approaches, emphasizing the comparison between utilizing client parameters and the principal innovation of this study—the softmax output from the last layer of the neural network. The table 1100 (Cross-Node Results) disclosed in FIG. 11 includes the findings, detailing accuracy and loss metrics concerning the baseline, thereby providing a comprehensive view of the efficacy of an embodiment.

In a comparative analysis with the FL Baseline, it was observed by the inventors that employing the softmax output from the last layer of the neural network for clustering purposes not only matched but also maintained the performance metrics. This method showcased a dual advantage. Firstly, it demonstrated efficiency in communication by reducing the volume of data transmitted during the learning process, an important factor in bandwidth-constrained FL environments. Secondly, it offered an increased level of security since only a portion of the client data, rather than the entirety of the client data, is shared during model updates.

Moreover, it has been observed that in certain scenarios, this strategic use of softmax output led to enhanced outcomes. This improvement was particularly pronounced when 1 and ⅔ of the clients functioned as champion nodes. On the other hand, it is interesting to note that for ⅓ of the champion node clients, clustering outcomes using client parameters were found to be superior. However, despite these variations, the most significant difference noted was a modest gain of 0.83% with the softmax approach, indicating that both methods of clustering provide similar levels of performance. These findings suggest that the employment of softmax clustering may be more advantageous, as it preserves accuracy while also considerably reducing the communication overhead, making it an appealing option for FL implementations where efficient communication is paramount.

As per the experimental setups shown in the table 900 of FIG. 9, the FL Baseline would require a total of 4,000 communication messages to complete the learning process. In contrast, the cross-node framework demonstrated significantly greater communication efficiency, needing only 2,632, 3,012, and 3,468 messages for configurations with 1, ⅓, and ⅔ champion nodes, respectively. Specifically, by choosing a one champion node configuration that provided performance comparable to the FL Baseline, cross-node achieved a 34.20% reduction in communication, thus evidencing a considerable gain in communication efficiency.

### F.4 Final Remarks

An embodiment comprises cross-node, an asynchronous federated learning framework that leverages the concept of “champion nodes” within clusters. In an embodiment, this approach employs random selection of champion nodes to contribute their weights to a central server for model aggregation, ensuring a broad exposure to the diversity of classes across clients.

Research conducted by the inventors included an extensive comparative analysis of an embodiment of cross-node against established frameworks like FL baseline. The findings reveal that such embodiment of cross-node not only matches the accuracy and loss metrics of its counterparts but also stands out by significantly reducing computational overhead-up to 34.20%. This reduction in resource utilization could be particularly advantageous in resource-constrained environments or applications where efficiency is paramount.

While one embodiment of cross-node did exhibit a maximum decrease in accuracy of 1.12% in comparison to FL baseline when working with the CIFAR-10 dataset, the savings in communication load that embodiment offers underscores its potential utility. The balance between performance and efficiency that cross-node provides is indicative of its suitability for real-world federated learning deployments where network bandwidth and energy consumption are critical factors.

Overall, the cross-node framework, according to one embodiment, may comprise a useful solution in the federated learning landscape, permitting that framework to enhance distributed learning processes by optimizing the trade-offs between model performance and system resource demands.

### G. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other byway of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### H. Further Example Embodiments

Following are some further example embodiments. These are presented only by way of example and are not intended to limit the scope of this disclosure or the claims in any way.

Embodiment 1. A method, comprising: sending a model to each node in a group of nodes that are connected with each other; receiving, from each of the nodes, a respective gradient for the model; running a federated learning process across the nodes, using the gradients to train the model; clustering the nodes into K clusters based on their respective gradients; selecting N champion nodes from the K clusters, where the N champion nodes represent all gradient results in each of the K clusters; receiving, from each of the N champion nodes, a respective gradient resulting from training of the model at the N champion nodes; aggregating the gradients, resulting from the training of the model at the N champion nodes, into a new or updated model; and repeating the federated learning, clustering, selecting of N champion nodes, receiving of the gradients resulting from the training of the N champion nodes, and aggregating the gradients until the model converges.

Embodiment 2. The method as recited in any preceding embodiment, wherein the gradients are received from the nodes asynchronously.

Embodiment 3. The method as recited in any preceding embodiment, wherein a number of the N champion nodes of one of the K clusters is less than all the nodes in that K cluster.

Embodiment 4. The method as recited in any preceding embodiment, wherein the nodes are clustered into K clusters based on a similarity of their respective gradients.

Embodiment 5. The method as recited in any preceding embodiment, wherein the N champion nodes are randomly selected.

Embodiment 6. The method as recited in any preceding embodiment, wherein similarity of the respective gradients of the N champion nodes facilitates fault tolerance if one of the N champion nodes fails.

Embodiment 7. The method as recited in any preceding embodiment, wherein the gradients received from the nodes were generated by training of the model, at each of the nodes, using data local to the nodes.

Embodiment 8. The method as recited in any preceding embodiment, wherein the N champion nodes are selected based on a likelihood that they will accurately reflect a behavior of the model after the model has converged.

Embodiment 9. The method as recited in any preceding embodiment, wherein each of the nodes corresponds to a respective edge device.

Embodiment 10. The method as recited in any preceding embodiment, wherein the federated learning continues even when a node in one of the K clusters fails.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### I. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

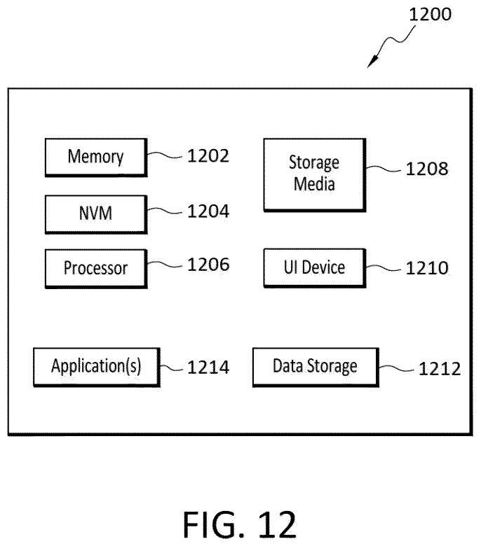

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
sending a model to each node in a group of nodes that are connected with each other;
receiving, from each of the nodes, a respective gradient for the model;
running a federated learning process across the nodes, using the gradients to train the model;
clustering the nodes into K clusters based on their respective gradients;
selecting N champion nodes from the K clusters, where the N champion nodes represent all gradient results in each of the K clusters;
receiving, from each of the N champion nodes, a respective gradient resulting from training of the model at the N champion nodes;
aggregating the gradients, resulting from the training of the model at the N champion nodes, into a new or updated model; and
repeating the federated learning, clustering, selecting of N champion nodes, receiving of the gradients resulting from the training of the N champion nodes, and aggregating the gradients until the model converges.

2. The method as recited in claim 1, wherein the gradients are received from the nodes asynchronously.

3. The method as recited in claim 1, wherein a number of the N champion nodes of one of the K clusters is less than all the nodes in that K cluster.

4. The method as recited in claim 1, wherein the nodes are clustered into K clusters based on a similarity of their respective gradients.

5. The method as recited in claim 1, wherein the N champion nodes are randomly selected.

6. The method as recited in claim 1, wherein similarity of the respective gradients of the N champion nodes facilitates fault tolerance if one of the N champion nodes fails.

7. The method as recited in claim 1, wherein the gradients received from the nodes were generated by training of the model, at each of the nodes, using data local to the nodes.

8. The method as recited in claim 1, wherein the N champion nodes are selected based on a likelihood that they will accurately reflect a behavior of the model after the model has converged.

9. The method as recited in claim 1, wherein each of the nodes corresponds to a respective edge device.

10. The method as recited in claim 1, wherein the federated learning continues even when a node in one of the K clusters fails.

11. A non-transitory storage medium having stored therein instructions that are executable by one or more hardware processors to perform operations comprising:
sending a model to each node in a group of nodes that are connected with each other;
receiving, from each of the nodes, a respective gradient for the model;
running a federated learning process across the nodes, using the gradients to train the model;
clustering the nodes into K clusters based on their respective gradients;
selecting N champion nodes from the K clusters, where the N champion nodes represent all gradient results in each of the K clusters;
receiving, from each of the N champion nodes, a respective gradient resulting from training of the model at the N champion nodes;
aggregating the gradients, resulting from the training of the model at the N champion nodes, into a new or updated model; and
repeating the federated learning, clustering, selecting of N champion nodes, receiving of the gradients resulting from the training of the N champion nodes, and aggregating the gradients until the model converges.

12. The non-transitory storage medium as recited in claim 11, wherein the gradients are received from the nodes asynchronously.

13. The non-transitory storage medium as recited in claim 11, wherein a number of the N champion nodes of one of the K clusters is less than all the nodes in that K cluster.

14. The non-transitory storage medium as recited in claim 11, wherein the nodes are clustered into K clusters based on a similarity of their respective gradients.

15. The non-transitory storage medium as recited in claim 11, wherein the N champion nodes are randomly selected.

16. The non-transitory storage medium as recited in claim 11, wherein similarity of the respective gradients of the N champion nodes facilitates fault tolerance if one of the N champion nodes fails.

17. The non-transitory storage medium as recited in claim 11, wherein the gradients received from the nodes were generated by training of the model, at each of the nodes, using data local to the nodes.

18. The non-transitory storage medium as recited in claim 11, wherein the N champion nodes are selected based on a likelihood that they will accurately reflect a behavior of the model after the model has converged.

19. The non-transitory storage medium as recited in claim 11, wherein each of the nodes corresponds to a respective edge device.

20. The non-transitory storage medium as recited in claim 11, wherein the federated learning continues even when a node in one of the K clusters fails.
